(19) United States
(12) Patent Application Publication
(10) Pub. No.: US 2007/0174091 A1
(43) Pub. Date: Jul. 26, 2007

(54) Methods, data structures, systems and computer program products for identifying obsure patterns in healthcare related data

(75) Inventors: Robert R. Friedlander, Southbury, CT (US); James R. Kraemer, Santa Fe, NM (US)

Correspondence Address: Elizabeth A. Stanek;Myers Bigel Sibley & Sajovec, P.A., P. O. Box 37428, Raleigh, NC, 27627, US

(73) Assignee: International Business Machines Corporation

(21) Appl. No.: 11/339,932

(22) Filed: Jan. 26, 2006

(51) Int. Cl. G06F 19/00; G06F 17/00

(52) U.S. Cl. 705/3; 707/104.1

(57) ABSTRACT

Methods, data structures, systems and computer program products are provided for identifying patterns in available healthcare related data. A triggering observation in the available healthcare related data is hierarchically related to at least one additional observation in the available healthcare related data based on a possible relationship between the triggering observation and the at least one additional observation in a computer database environment.

### FIELD OF THE INVENTION

The invention relates to data processing in general and, more particularly, to organization of data.

### BACKGROUND OF THE INVENTION

As the number of serious contagious conditions, for example, Severe Acute Respiratory Syndrome (SARS), the Avian Flu (H5N1) and the like, continue to increase, the need to identify these conditions early become more important. However, the early identification of these conditions may be very difficult. For example, an increase in the number of children absent from school does not, on its face, appear to indicate the onset of a serious contagious condition, but this data combined with other information may, in hindsight, be predictive of the serious contagious condition. It is difficult to identify data of interest because each of the pieces by themselves may appear innocuous, but when the pieces are all put together they may reveal an epidemic.

### SUMMARY OF THE INVENTION

Some embodiments of the present invention provide methods, data structures, systems and computer program products for identifying patterns in available healthcare related data. A triggering observation in the available healthcare related data is hierarchically related to one or more additional observations in the available healthcare related data based on a possible relationship between the triggering observation and the at least one additional observation in a computer database environment.

In further embodiments of the present invention, a request is received specifying the triggering observation at the computer database environment. The one or more additional observations possibly associated with the specified triggering observation may be received responsive to the request.

In still further embodiments of the present invention, a likelihood that the triggering observation and the one or more additional observations indicate a possible problem exceeds a predetermined threshold may be determined. An alert indicating that the predetermined threshold has been exceeded may be generated if it is determined that the predetermined threshold has been exceeded.

In some embodiments of the present invention, the one or more additional observations of events may include observations of events occurring at different times within a specified time period and/or a specified location.

In further embodiments of the present invention, the triggering observation may be identified based on at least one identified pattern defining healthcare events. The identified patterns may be fine tuned and/or added to the computer database environment based on the triggering observation and/or the one or more additional observations.

### BRIEF DESCRIPTION OF THE DRAWINGS

FIG. 1 is a block diagram illustrating systems according to some embodiments of the invention.

FIG. 2 is a block diagram illustrating some embodiments of the present invention in an exemplary network environment.

FIG. 3 is a schematic illustration of hierarchical relationships between a triggering observation and one or more additional observations in a database environment according to some embodiments of the invention.

FIG. 4A is diagram illustrating a location of a triggering observation and the possible predefined location for additional observations according to some embodiments of the present invention.

FIG. 4B is a graph of location vs. time illustrating the location and time of the triggering observation and possible additional observations according to some embodiments of the present.

FIG. 5 is a block diagram illustrating operations of systems according to some embodiments of the invention.

FIGS. 6 and 7 are flowcharts illustrating operations according to various embodiments of the present invention.

### DETAILED DESCRIPTION OF EMBODIMENTS OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data structure, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described in part below with reference to a flowchart illustration and/or block diagrams of methods, systems, computer program products and data structures according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

In the process of containing and identifying contagious diseases/viruses, public health authorities try to determine a “first case” of the virus, i.e. try to identify the source of the virus in the particular area (the first person to contract the virus). However, the task of identifying the “first case” may be difficult because by the time a person is diagnosed correctly, the virus has typically been out in the community for r hours or even days. Thus, there is a need for earlier diagnosis of patients as well as earlier identification of the “first case,” as this may aid in containing the virus.

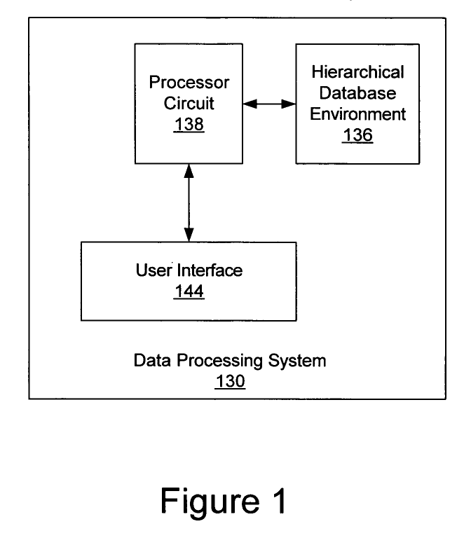

Thus, according to some embodiments of the present invention, methods, data structures, systems and computer program products may provide the ability to timely identify a “first case” of a contagious disease, for example, SARS, the Avian Flu and the like. Identifying the “first case”, i.e., the first person that contracted the virus, is a very important step in containing the virus. Furthermore, some embodiments of the present invention may provide relatively early identification of a possible epidemic. For example, embodiments of the present invention may not wait for an actual diagnosis before dealing with a possible virus outbreak. According to some embodiments of the present invention, various information databases may be searched to identify observations that may indicate the onset of an epidemic or outbreak of a virus. If the observations are verified, an alert may be issued to make healthcare providers aware of the possible outbreak and, therefore, allow earlier diagnosis of patients as well as early identification of the “first case.” The earlier the epidemic is identified and the earlier the “first case” is found, the easier the virus can be contained, which will be discussed further below with respect to FIGS. 1 through 7.

Although some embodiments of the present invention are discussed herein with respect to contagious illnesses, such as SARS and Avian Flu, embodiments of the present invention are not limited to this configuration. For example, some embodiments of the present invention may be used to predict nation and man made pathogens, such as human released material pathogens, toxic chemicals, radiological items and the like without departing from the scope of the present invention.

Embodiments of the present invention will now be discussed with respect to FIGS. 1 through 7. As described herein, some embodiments of the present invention provide a database environment for storing “healthcare related data.” As used herein, “healthcare related data” may include measured/recorded data and/or data from information streams that may indicate an issue related to healthcare. For example, the measured/recorded data may include body temperatures measured with thermo cameras located in public places, recorded conditions of public restrooms, evidence of certain types of coughs recorded by microphones positioned in public places, traffic data (increase and/or decrease thereof), increase in the purchase of certain types of over the counter drugs, attendance numbers of schools and businesses and the like. Data obtained from information streams may include intercepted text and/or voice mail messages indicating fever, coughs, general malaise and the like, information related to where/when emergency vehicles were dispatched, information from airplanes that one or more passengers on planes are not feeling well, medical charts including symptoms of patients in clinics, emergency rooms, doctors' offices and the like. Healthcare related data will be discussed further herein below.

According to some embodiments of the present invention a triggering observation may be identified in the available healthcare related data in the database environment. As used herein a “triggering observation” refers to any observation, for example, a reduction in the amount of traffic through the Holland tunnel from New Jersey to New York City, that may appear inconsistent or interesting. For example, a triggering observation may be, for example, a reduction in the amount of traffic through the Holland Tunnel from New Jersey to New York City. This may be a triggering observation based on the fact that over the past five years the traffic through the Holland tunnel on this day, in this time period was twenty percent more. Once this triggering observation is identified in the database environment, one or more additional observations that may or may not be related to the triggering observation may be identified. As used herein, “additional observations” refer to any event that may appear inconsistent with previous data/experiences or interesting and may possibly be related to the triggering observation. The additional observations may have occurred within a predetermined time period of the triggering observation, for example, twenty-four hours before or after the triggering observation, and/or within a predetermined distance of the location of the triggering observation, for example, within a thirty-mile radius, sixty minutes highway travel time, or thirty minutes by commuter rail. Additional observations may be, for example, that the traffic over the George Washington bridge and through the Lincoln Tunnel from New Jersey to New York were also statistically lower than usual and the absentee rate of New York businesses was increased in proportion to the reduced traffic flow over the George Washington Bridge and through the two tunnels.

Relationships between the triggering observation and the additional observations may be identified. For example, the relationship may be that the reduced traffic flow is in direct proportion to the increased absenteeism, which may indicate absenteeism due to illness. Once this relationship has been established, an alert indicating that a predetermined threshold, i.e., the correlation between absenteeism and traffic, has been met may be generated. The threshold may be customized by the user. At this point a person, for example, healthcare personnel or CDC personnel, may look at these observations more closely and an investigation may be opened. Thus, according to some embodiments of the present invention, first degree relationships may be established between a plurality of events that may themselves seem unrelated. Furthermore, once these first degree relationships are established, the seemingly unrelated individual events may convey a different story as discussed further herein below.

For example, the reduced traffic flow, in combination with the increase in absentee rate of New York businesses may indicate the on set of a contagious illness. Therefore, according to some embodiments of the present invention this out break may be identified before a single person is diagnosed as having a particular illness. This may allow for earlier diagnosis of patients as well as easier and faster identification of the “first case” as will be discussed further herein.

Referring now to FIG. 1, a block diagram illustrating systems, for example, data processing system 130, according to some embodiments of the invention will be discussed. In particular, a hierarchical database environment 136 operates under the control of a processor circuit 138. The processor circuit 138 can be a general purpose processor circuit within a general purpose or application specific computer. As described above, the processor circuit 138 may use elements of both hardware and software to carry out the functions described herein.

The system 130 also includes a user interface 144. The user interface device 144 may include, for example, a keyboard or keypad, a display, microphone, speaker and/or other types of input/output functionality that may enable the user to interact with the hierarchical database environment 136 via the processor circuit 138. It will be understood that the elements shown in FIG. 1 may operate on a single computer system or may be distributed among two or more computer systems that operate in cooperation with one another to carry out the operations described herein. The two or more computers may communicate with one another over a network, such as a local area network.

The hierarchical database environment 136 is configured to store healthcare related data. The healthcare related data may be collected from databases, such as databases maintained by the highway authorities (condition of highway restrooms, traffic flow), databases maintained by public institutions (thermo camera information, microphone information), databases maintained by school system (attendance information), medical institution databases and the like. Within this healthcare related data, triggering observations may be identified. Furthermore, one or more additional observations may be identified based on a possible relationship between the triggering observation and the one or more additional events. For example, the relationships may indicate that the number of people shopping at the mall having elevated temperatures corresponds directly to the increase in the purchase of certain over the counter drugs in the mall pharmacy.

Thus, for example, the triggering observation may be the elevated temperatures of 15% percent of mall patrons taking into account time of year, temperature, season and the like. According to some embodiments of the present invention, the processor 138 may be configured to search the hierarchical database environment 136 for additional observations that may possibly be related to the triggering observation. For example, the purchase of over the counter drugs for fevers by mall patrons has increased 15%. This event may be identified as an additional observation associated with the triggering observation. In one scenario, the increase in over the counter drugs may indicate that people are just beginning to feel bad. People typically try to self medicate, i.e., over the counter drugs, before going to the doctor, clinic or emergency room. Thus, according to some embodiments of the present invention, the symptoms may be identified before a single patient goes to a doctor.

The processor 138 may be further configured to search the database 136 for events in a specified time period and/or location. For example, the database may be configured to search for events twenty-four hours before and/or after the triggering observation in a thirty-mile radius around the location of the triggering observation. For example, the data recorded by thermo cameras in public places within thirty miles of the mall may be searched to determine if the data recorded by these cameras also shows that 15% or more of the people have elevated temperature. It will be understood that these time periods and distances are provided for exemplary purposes only and that embodiments of the present invention are not limited to this configuration. For example, the search area and time period may be user customizable. For example, if the database 136 was being used by a local health department, the distance specification may be much more limited than if the database 136 was being used by the center for disease control (CDC). The triggering observation and the additional observations, referred to collectively as observations, may be stored separately in a memory of the hierarchical database environment 136.

In some embodiments of the present invention, a user, for example, a healthcare provider, may access the hierarchical database environment 136 to request healthcare related data associated with a triggering observation. Because the triggering observation is hierarchically related to possibly related additional observations, the hierarchical database environment 136 can provide the healthcare related data for user access in a more convenient fashion.

In certain embodiments of the present invention, the healthcare related data stored in the hierarchical database environment 136 may be searched and analyzed using conventional data mining tools, such as IBM Intelligent Miner, SAS Enterprise Miner and the like. Thus, these data mining tools may be used to identify patterns in the healthcare related data stored in the database(s), which may possibly be useful in identifying interesting observations that may possibly lead to, for example, a virus outbreak. For example, the database may include a list of symptoms that are commonly associated with common viruses, for example, SARs or the Avian Flu. If the healthcare related data illustrates that one or more of these symptoms is prevalent in a certain area, the database 136 may be configured to search for one or more of the other symptoms that are also indicative of the virus within a certain location and time period of the report of the other symptom(s). These patterns may be changed over time, for example, new symptoms may be added over time.

In some embodiments of the present invention, the patterns may be changed manually by a user, for example, a healthcare provider. The patterns may be adjusted for perturbations, such as season of the year, month of the year, day of the week, time of day, holidays, cultural and sporting events, geographic location, climatic norms and/or environmental norms and abnormalities. It will be understood that the adjustments to the patterns may be performed automatically by systems according to some embodiments of the present invention. Furthermore, systems according to some embodiments of the present invention may be configured to discover and/or remember normal patterns including adjustments for perturbations, such as season of the year, month of the year, day of the week, time of day, holidays, cultural and sporting events, geographic location, climatic norms and/or environmental norms and abnormalities and the like without departing from the scope of the present invention.

In certain embodiments of the present invention, healthcare related data may be retrieved using query tools, such as SQL, MicroStrategy, BusinessObject, Cognos and the like. Furthermore, some embodiments of the present invention may be used in combination with existing database software, such as DB2 from International Business Machines, Armonk, N.Y., the assignee of the present application. Other database software that may be used in some embodiments of the present invention includes Oracle from Oracle of Redwood Shores, Calif., SQL Server from Microsoft Corporation of Redmond, Wash. and Sysbase from Sysbase of Dublin, Calif. The exemplary database software provided herein is provided for exemplary purposes only and embodiments of the present invention are not limited to these examples.

In some embodiments according to the invention, the observations are stored in the hierarchical database environment 136 in data structures that are hierarchically linked. For example, healthcare related data related to different institutions can be hierarchically related to one another because the institutions are within a certain radius of one another and people associated with the institutions experienced similar symptoms of interest.

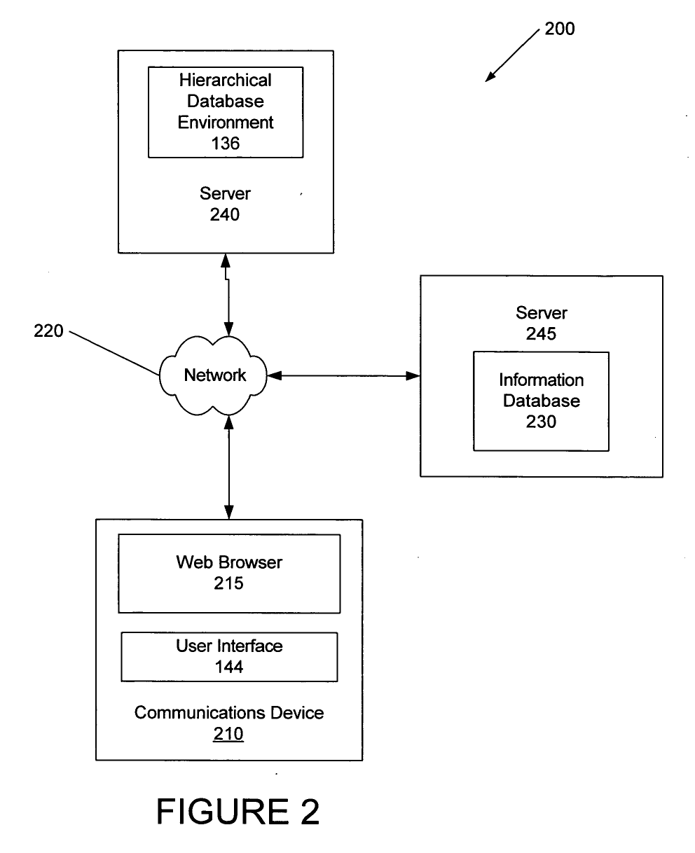

Methods of collecting and storing data in databases are known to those having skill in the art and, therefore, will not be discussed in detail herein. An exemplary method of collecting and storing data in databases will be discussed with respect to FIG. 2. A block diagram illustrating an exemplary environment for healthcare related data according to some embodiments of the present invention is illustrated in FIG. 2.

As illustrated, the environment 200 may include a communications device 210, a network 220 and first and second servers 240 and 245. The communications device 210 may be, for example, a laptop computer, a desktop computer, a personal data assistant (PDA), a web capable mobile terminal or any device capable of communicating with the network 220. The communications device 210 may communicate over the network 220, for example, the internet, through a telephone line, a digital subscriber link (DSL), a broadband cable link, a wireless link or the like. The first and second servers 240 and 245 may also communicate over the network 220. Thus, the network 220 may convey data between the communications device 210 and the first and second servers 240 and 245.

As further illustrated, the communications device may include a web browser 215 that may be accessed through the user interface 144. The web browser 215 may allow, for example, a doctor, CDC personnel, a medical researcher or the like, access to a text or graphical interface used to enter information related to a triggering observation. For example, the web browser may include a graphical interface that requests such information as a name of a person or persons associated with the triggering observation (if any), their address, phone number and the like, the type of observation/event, for example, an emergency room visit, and the date and time of the event. Furthermore, as the healthcare related data is collected, for example, number of over the counter drugs purchased, it may be entered using the graphical user interface on the web browser 215. Once healthcare related data is entered into the graphical user interface, the user may indicate that the healthcare related data be stored in the hierarchal database environment 136 by, for example, pressing an enter key on a keypad. The web browser 215 may communicate the healthcare related data over the network 220 to the first server 240, which may then store the healthcare related data in the hierarchal database environment 136 on the first server 240.

It will be understood that although healthcare related data may be stored in the database 136 by a user of the computing device 210 as discussed above, embodiments of the present invention are not limited to this configuration. For example, the database 136 may be configured to watch external databases, for example, databases maintained by the highway authorities (condition of highway restrooms, traffic flow), databases maintained by public institutions (thermo camera information, microphone information), databases maintained by school system (attendance information), medical institution databases and the like, for interesting events, which may be automatically stored in the database 136 without departing from the scope of the present invention as will be discussed further below. Furthermore, in some embodiments of the present invention, a pointer to the information stored in the external databases is stored in the database 136 instead of storing the information itself. This may allow the database 136 to operate with much less memory associated therewith.

Furthermore, a user, for example, a healthcare provider, may also use the web browser 215 to search and analyze the healthcare related data stored in the hierarchal database environment 136. As illustrated in FIG. 2, the second server 245 may include information databases 230 including, for example, databases maintained by the highway authorities (condition of highway restrooms, traffic flow), databases maintained by public institutions (thermo camera information, microphone information), databases maintained by school system (attendance information), medical institution databases and the like. In some embodiments of the present invention, the information databases 230 may include and/or have access to text based information. For example, the healthcare provider may extract discrete and/or syntactical semantic data from the text based sources, for example, medical charts, text messages and the like. The Healthcare provider may use these information databases 230 to obtain information about additional observations that could be possibly related to the triggering observation as discussed further below. The information in the information databases 230 may provide further support that a flagged observation indicated a possible problem may lead to, for example, an outbreak of a serious illness. It will be understood that the environment 200 provided in FIG. 2 is provided for exemplary purposes only and that embodiments of the present invention are not limited to this configuration.

Furthermore, methods, data structures, systems and computer program products according to some embodiments of the present invention may be capable of providing observations and/or information from the hierarchical database 136 and/or the external databases, for example, information databases 230, based on who user is, i.e. what group does the user belong to and what is his/her role/title. For example, if the user is a CDC employee, the observations/information provided may include, but is not limited to, information provided in medical charts. Other text based evidence that may be searched and provided according to some embodiments of the present invention may include, but is not limited to, text messages, voice messages that have been processed and formatted as text, emergency dispatch information, public restroom condition charts, attendance charts for schools and/or businesses and the like. In some embodiments of the present invention, these text based evidence databases may be searched without being designated to be searched, i.e., searched automatically without user intervention. These text based evidence databases may also be designated to be searched without departing from the scope of the present invention.

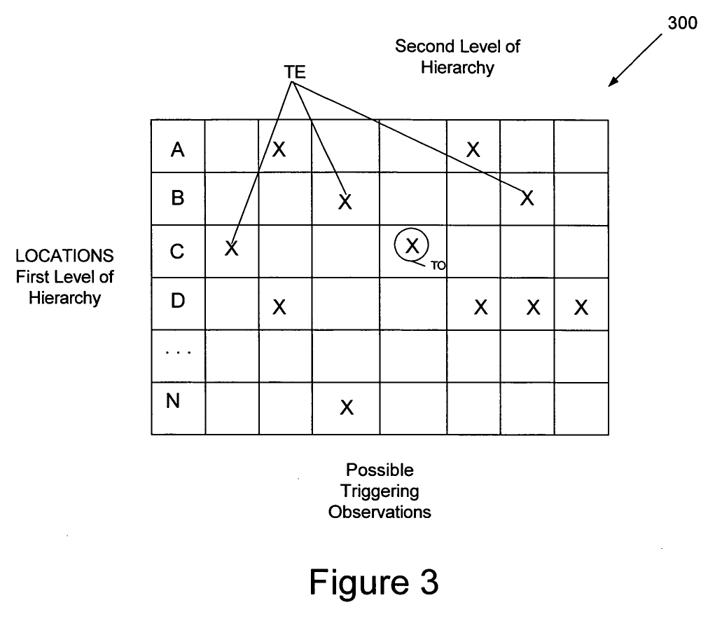

Referring now to FIG. 3, a schematic representation of healthcare related information stored in a hierarchical database environment 136 according to some embodiments of the invention will be discussed. Table 300 in FIG. 3 illustrates an unstructured arrangement of healthcare related data occurring at locations A through N for the purpose of illustrating the hierarchical relationship of the data stored therein to the triggering observation (TO) according to some embodiments of the invention. As used herein, “unstructured” healthcare related data refers to data that does not necessarily logically fit together well at first glance, i.e., data that may be seemingly innocuous. It will therefore be understood that the unstructured healthcare related data in table 300 is used to describe the hierarchical relationship between the healthcare related data stored therein and the triggering observation.

It will be understood that each of the Xs in Table 300 represents healthcare related data for different locations A through N either entered by a user or obtained from one or more external databases, for example, a hospital database. This illustrates a first level of hierarchy. For example, the “X's” may correspond to specific observations that occurred in the indicated location within a particular time period. For example, two observations may have occurred in location A in the particular time period. As illustrated, a triggering observation (TO) may be identified in the database environment in location C. Once this triggering observation (TO) is identified, the user may specify a specific location and/or time period to be searched for additional observations that may be possibly related to the triggering observation. As illustrated in FIG. 3, two events in location B and one event in location C have been identified as additional observations that may possibly be related to the triggering observation (TO). This illustrates a second level of hierarchy in the database.

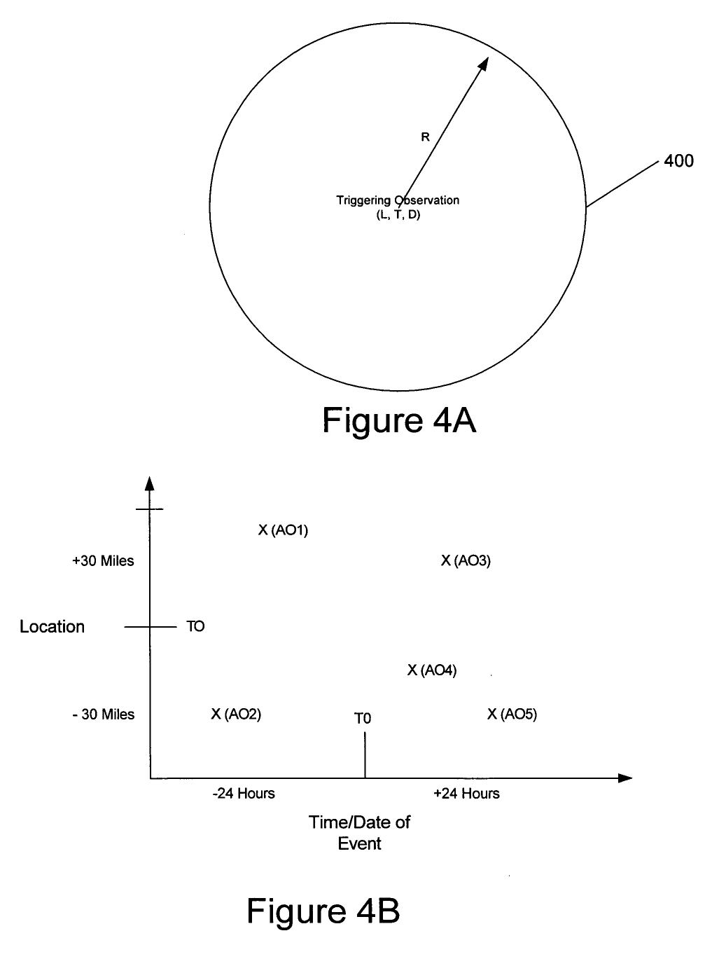

Referring now to FIG. 4A, a diagram illustrating a search region according to some embodiments of the present invention will be discussed. As discussed above, a triggering observation may be identified using a database according to some embodiments of the present invention. The triggering observation may have an associated location, time and date (L, T, D). Thus, a search region 400 may be identified based on the location of the triggering observation. For example, if the triggering observation occurred in New York City, the search region 400 may be identified by a thirty-mile radius R around New York City (the location of the triggering observation). As discussed above, the size of the search region 400 may be customized by the user. Thus, if the user is the CDC, the search region 400 may be much larger than if the user is a local health official.

Referring now to FIG. 4B, a graph that illustrates location versus time of the triggering observation and additional observations according to some embodiments of the present invention will be discussed. Similar to the search region 400, the time period of the search may be set based on the date and time of the triggering observation. For example, as shown in FIG. 4B, the time period for the search may be forty-eight hours before and/or after the occurrence of the triggering observation. As discussed above, this time period may be customizable by the user and may vary greatly depending on the user's objective. As further illustrated in FIG. 4B, the healthcare related data may be collected at different times and locations. According to some embodiments of the present invention, these additional observations (AE1 to AE5) may be identified as possibly related to the triggering observation (TO), which may otherwise be difficult to access in an unstructured database.

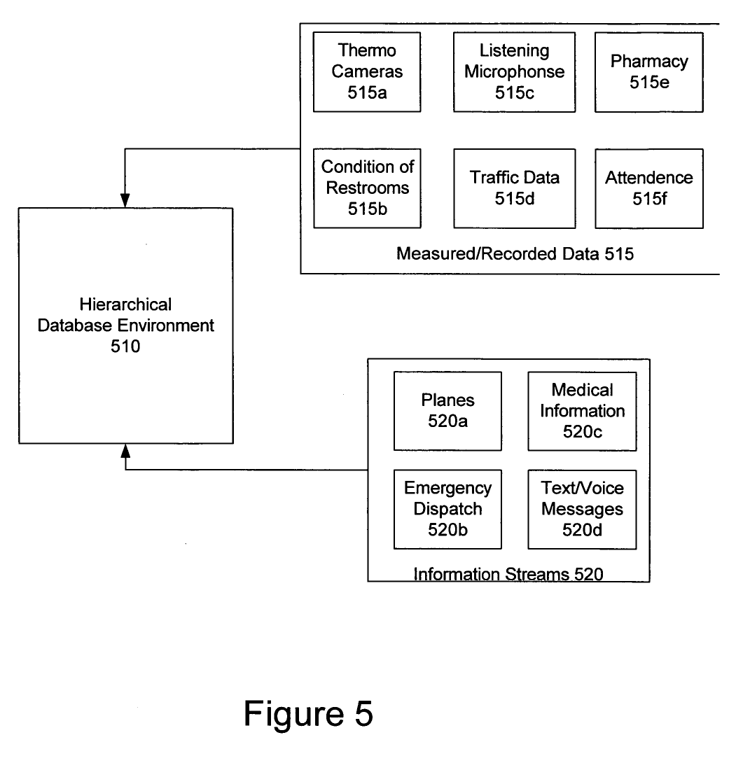

Referring now to FIG. 5, a block diagram that illustrates operations of hierarchical database environments according to some embodiments of the invention will be discussed. In particular, a database environment 510 according to some embodiments of the invention can operate as described above and may access measured/recorded data 515, as well as information streams 520.

In operation, a user, for example, a healthcare provider may operate the hierarchical database environment 510 to identify healthcare related data associated with a triggering observation to investigate potential relationships among the data for the purposes of, for example, thwarting an outbreak of a particular illness. In some embodiments of the present invention, the user may operate the hierarchical database environment 510 to access additional observations associated with the triggering observation. By accessing the healthcare related data in this way, the data may be viewed in a more hierarchical fashion, thereby enabling the user to further investigate a potential relationship, for example, between a decrease in traffic and an increase in absenteeism from work and/or school by accessing a pharmacy database 515e included among the databases including measures/recorded data 515. In other words, the pharmacy database 515e may be used to provide information with respect to the over the counter drugs purchased, which may give the healthcare provider insight into why people are absent from work and/or school. Because people tend to self medicate before going to the doctor, an increase in the purchase of over the counter drugs may indicate that people are absent from work and/or school because they are not feeling well.

If the data in the pharmacy databases 515e indicates that the purchase of over the counter drugs have increased, the user may further access other information related to the individuals who purchased the over the counter drugs, for example, information streams 520 associated with these individuals. For example, the information streams may include current text/voice messages 520d sent by one or more of these individuals. For example, one of these individuals, for example, may have also sent a text message to a friend indicated that he or she was not feeling well. This may be useful in identifying a possible outbreak of an illness as it further confirms that people may be absent from work due to illness.

It will be understood that the measured and/or recorded data databases 515 can include further sources, such as thermo camera databases 515a, restroom condition databases 515b, listening microphone databases 515c, traffic data databases 515d, attendance databases 515f and any other measured/recorded data databases that may include useful healthcare related data according to some embodiments of the present invention. Each of these databases will be discussed below.

Thermo cameras may be positioned in public places, for example, shopping malls, train stations, public school cafeteria doors, airports and the like. The temperatures recorded by the thermo cameras may be stored in a thermo camera database(s) 515a and the information stored may be used according to some embodiments of the present invention. It will be understood that normal body temperatures are typically so variant that measurement of individual temperatures alone may not be useful. However, in context, the measurement of many temperatures over time that may be adjusted based on the season of the year, outside temperature, amount of clothing worn and the like, may be useful in identifying groups of people that have fevers according to some embodiments of the present invention. Thus, for example, if it is observed that 15% percent of people in an airport appear to have elevated body temperatures (fevers), this may be a triggering event according to some embodiments of the present invention.

Conditions of restrooms located, for example, on a highway, such as highway 95, may be recorded and stored in a database 515b. For example, these restrooms may be inspected every hour and may be electronically reported to the state highway department. This information may be indicative of illness. For example, when people are ill they may vomit or may have diarrhea. When a restroom attendant inspects the restroom, these conditions may be readily apparent. Thus, the restroom attendant may include this information in the chart for the restroom. This information may be accessed by the hierarchical database 510 according to some embodiments of the present invention. If the information in the database 515b indicates the presence of vomit in restrooms on 95 North between Maryland and Virginia, this may be a triggering observation according to some embodiments of the present invention. Information associated with restrooms on planes, trains, busses, military barracks, police offices, shopping malls and the like may also be used.

Listening devices may also be positioned in public places, for example, shopping malls, train stations, airports and the like. The sounds recorded by the listening devices may be stored in a listening device database(s) 515c and the information stored may be used according to some embodiments of the present invention. It will be understood that many of the sounds of sickness, coughing, sneezing, blowing ones nose and the like may be picked up by the listening device and stored in the database 515c. It will be understood that a cough indicative of certain conditions may be very distinctive and may be recognized by a digital signal processor (DSP) coupled to the listening device. Thus, if it is observed that 20% of people in the public arena are exhibiting sounds associated with illness or the number of distinctive coughs exceeds some numeric threshold, this may be a triggering event according to some embodiments of the present invention.

It will be understood that although some embodiments of the present invention are discussed with respect to percentages of people and the like, thresholds according to embodiments of the present invention customizable. In other words, thresholds may be set after analysis by medical, statistics, governmental health and/or national security officials as appropriate. The thresholds may be customizable by a user (s) based on the situation, security policies and procedures and the like.

Many roads, tunnels, bridges and the like have systems in place to measure the amount of traffic traveling on the roads, in the tunnels and over the bridges. This information may be stored in a traffic database 515d accessible by the database 510 according to some embodiment of the present invention. Patterns of traffic may be established for times of day, times of year, and the like. If a deviation in these patterns in sensed, this may be a triggering observation according to some embodiments of the present invention. For example, if the traffic patterns indicate that unusual number of people or vehicles are leaving the city at mid-day, this may be a triggering observation. The traffic databases 515d may also include information related to subway traffic, railroad traffic and the like without departing from the scope of the present invention.

As discussed above, a pharmacy database 515e may include information about people who are buying over the counter drugs, what types of drugs they are buying and in what quantities. This information may provide information one half to a full day earlier than typical, as people usually self medicate before going to a doctor emergency room or clinic. According to some embodiments of the present invention, a pattern in the purchase of over the counter drugs, such as a spike in the purchase thereof, may be a triggering observation according to some embodiments of the present invention. The purchase of prescription drugs as well as tissues, eye drops and the like may also be used according to some embodiments of the present invention.

Attendance of schools and businesses may be an indication of illness if attendance is down relative to similar times of the years, locations etc. in the past. This information may be stored in an attendance database 515f and may be accessible by the database 510 according to some embodiments of the present invention. A 20% drop in attendance that is statistically inconsistent may be a triggering observation according to some embodiments of the present invention.

It will be further understood that the information streams 520 may further include information streams from planes or other modes of transportation 520a, information streams associated with emergency dispatch vehicles 520b, information streams associated with medical information 520c and the like. Each of these information streams will be discussed below.

Airplane personnel as well as personnel on other modes of public transportation may report sick passengers. Doctors may receive this information and may provide medical advice so that the passenger may be treated in transit. According to some embodiments of the present invention, this information may be intercepted and may form the basis of a triggering observation as discussed herein. For example, a 747 traveling from Asia to New York may call the “Doctor Line” three times to report sick passengers. These passengers may be infected with, for example, the Avian flu. Accordingly, an alert according to some embodiments of the present invention and the plane may be met by The healthcare provider. The passengers of the entire plane may be quarantined until the situation is investigated. Thus, an outbreak in New York City may be thwarted by early observation of a potential problem according to some embodiments of the present invention.

Emergency dispatch vehicles may be sent to pick up people who call “911” and explain how they are feeling and why they need to go to the hospital. This information in both text and voice form may be provided in the emergency dispatch database 520b accessible by the hierarchical database according to some embodiments of the present invention. It will be understood that if the information is provided in a voice call to “911,” this voice call may be processed and formatted into a text form usable by the database 510. This information is very useful for early detection of illness outbreaks because the call may occur hours before a diagnosis of the patient and/or a call from the emergency room to the CDC. Thus, identifying a “911” call complaining of fever and vomiting as a triggering observation according to some embodiments of the present invention may limit exposure to the illness. Furthermore, if the one or more other observations occur at different emergency rooms, this pattern may not be recognized. However, according to some embodiments of the present invention the information from all the emergency rooms may be available, therefore, allowing a pattern to be recognized. Again, a few hours can make a huge difference and quarantines may be put in place to limit the exposure to surrounding areas.

Medical information, for example, information recorded by doctors in emergency rooms, clinics, offices etc. may be stored in a database 520c that is accessible by the database 510 according to some embodiments of the present invention. This information typically comes too late as by the time this information is reported, the exposure the community has already been great. However, this information may be useful in confirming diagnosis/suspicions according to some embodiments of the present invention.

As discussed above, text/voice messages may be monitored for keywords, such as fever, illness, headache, vomit, diarrhea and the like. This information may be stored in a database 520d that may be accessible by the database 510 according to some embodiments of the present invention.

It will be understood that the measured/recorded data 514 and the information streams 520 in FIG. 5 are provided for exemplary purposes only and, thus, embodiments of the present invention are not limited to the content thereof. It will also be understood that some of these databases contain private information, which may only be accessed by those having clearance to do so. For example, information streams available to some embodiments of the present invention may vary depending on which part of the world the information is coming from based on the privacy laws thereof.

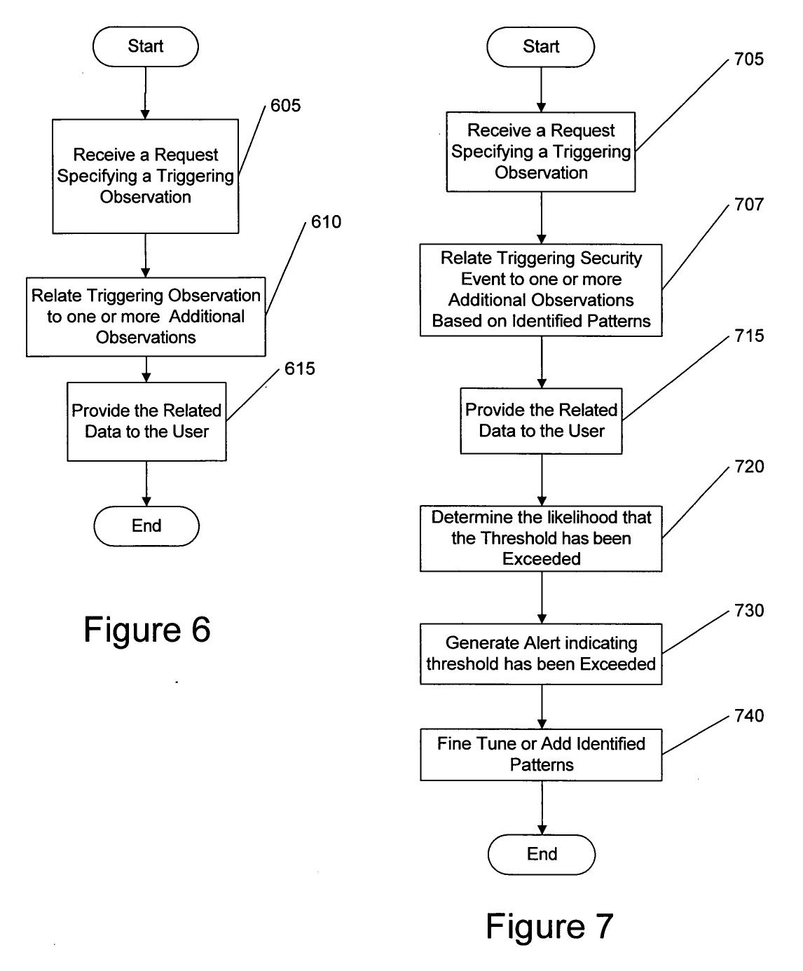

Referring now to FIGS. 6 and 7, flowcharts illustrating operations of hierarchical database environments according to various embodiments of the present invention will now be discussed. In some embodiments according to the invention, a request that specifies a triggering observation is provided to the hierarchical database environment (block 605). As described above, the triggering observation may identify any inconsistent and/or interesting pattern. For example, in some embodiments according to the invention, the triggering observation may be a decrease of 20% of all traffic entering New York City.

The hierarchical database environment can be used to locate and identify additional observations that may be related to the triggering observations (block 610). The additional observations may be removed from the triggering observation in both time and location. These may be set as parameters of the search. In some embodiments of the present invention, the possible relationship between the triggering observation and the at least one additional observation may be a relationship between unrelated instances, for example, school attendance and traffic. For example, in some embodiments according to the invention, the database may be used to determine that a decrease in traffic directly corresponds to an increased absentee rate. As discussed above, the additional observations may be identified in the database using conventional data mining techniques. Thus, the related observations may be provided to the user in a format that can be analyzed to possibly thwart an outbreak of an illness (block 615).

Referring now to FIG. 7, a request that specifies a triggering observation is provided to the hierarchical database environment (block 705). The hierarchical database environment can be used to locate and identify additional observations that may be related to the triggering observations based on identified patterns and rules (block 707). The related observation may be provided to the user in a format that can be analyzed to possibly thwart an outbreak of an illness (block 715). A likelihood that the triggering observation and the at least one additional observation are related exceeds a predetermined threshold may be determined (block 720). For example, if ten people on three different planes coming from Asia reporting the same symptoms associated with the Avian flu, this may cause the threshold to be exceeded because an adequate relationship between the events has been established. An alert may be generated indicating that the predetermined threshold has been exceeded if it is determined that the predetermined threshold has been exceeded (block 730). Thus, once the observations reach an alert level, CDC personnel may be alerted about the identified observations. The CDC personnel may then look into the situation and take action if necessary.

In some embodiments of the present invention, the patterns and/or rules may be fine-tuned based on the triggering observation and/or the at least one additional observation (block 740). In other words, the database environment may learn and add patterns as different ones are identified. The patterns may be identified based on, for example, measured/recorded data and/or information streams.

It will be understood that the circuits and other means supported by each block and combinations of blocks can be implemented by special purpose hardware, software or firmware operating on special or general-purpose data processors, or combinations thereof. It should also be noted that, in some alternative implementations, the operations noted in the blocks may occur out of the order noted in the figures. For example, two blocks shown in succession may, in fact, be executed substantially concurrently, or the blocks may sometimes be executed in the reverse order.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A method of identifying patterns in available healthcare related data comprising hierarchically relating a triggering observation in the available healthcare related data with at least one additional observation in the available healthcare related data based on a possible relationship between the triggering observation and the at least one additional observation in a computer database environment.

2. The method of claim 1, further comprising:
receiving a request specifying the triggering observation at the computer database environment; and
providing the at least one additional observation possibly associated with the specified triggering observation responsive to the request.

3. The method of claim 2, further comprising:
determining a likelihood that the triggering observation and the at least one additional observation indicate a possible problem exceeds a predetermined threshold; and
generating an alert indicating that the predetermined threshold has been exceeded if it is determined that the predetermined threshold has been exceeded.

4. The method of claim 1, wherein the at least one additional observation comprises observations of events in the data of interest, the events occurring at different times within a specified time period and/or a specified location.

5. The method of claim 1, further comprising identifying the triggering observation based on at least one identified pattern defining healthcare events.

6. The method of claim 5, further comprising fine tuning the identified patterns and/or adding identified patterns to the computer database environment based on the triggering observation and/or the at least one additional observation.

7. The method of claim 6, further comprising automatically fine tuning the identified patterns and/or adding the identified patterns based on normal patterns, the normal patterns including season of the year, month of the year, day of the week, time of day, holidays, cultural and sporting events, geographic location, climatic norms and/or environmental norms and abnormalities.

8. A data structure for identifying patterns in available healthcare related data in a computer database environment embodied in a computer readable medium, comprising:
a triggering observation object at a first level of hierarchy in a computer database environment; and
at least one additional observation object at a second level of the hierarchy in the computer database environment that is lower than the first level of the hierarchy, wherein the at least one additional observation objects are identified based on a possible relationship between the triggering observation object and the at least one additional observation object.

9. The data structure of claim 8, wherein the at least one additional observation object comprises observations of events in the data of interest, the events occurring at different times within a specified time period and/or a specified location.

10. A system for identifying patterns in available healthcare related data comprising:
a database environment configured to store a triggering observation object at a first level of hierarchy in a computer database environment and at least one additional observation object at a second level of the hierarchy in the computer database environment that is lower than the of the first level of the hierarchy, wherein the at least one additional observation object is identified based on a possible relationship between the triggering observation object and the at least one additional observation object; and
a processor circuit configured to hierarchically relate the triggering observation object to the at least one additional observation object.

11. The system of claim 10, wherein the processor circuit is further configured to receive a request specifying the triggering observation object and provide the at least one additional observation object possibly associated with the specified triggering observation object responsive to the request.

12. The system of claim 10, wherein the processor is further configured to determine a likelihood that the triggering observation object and the at least one additional observation object are related exceeds a predetermined threshold and generate an alert indicating that the predetermined threshold has been exceeded if it is determined that the predetermined threshold has been exceeded.

13. The system of claim 10, wherein the at least one additional observation comprises observations of events in the data of interest, the events occurring at different times within a specified time period and/or a specified location.

14. The system of claim 10, wherein the processor is further configured to identify the triggering observation object based on at least one identified pattern defining healthcare events.

15. The system of claim 14, wherein the processor is further configured to fine tune the identified patterns and/or add identified patterns to the database environment based on the triggering observation object and/or the at least one additional observation object.

16. A computer program product for identifying patterns in available healthcare related data, the computer program product comprising:
computer readable storage medium having computer readable program code embodied in said medium, the computer readable program code comprising:
computer readable program code configured to hierarchically relate a triggering observation in the available healthcare related data with at least one additional observation in the available healthcare related data based on a possible relationship between the triggering observation and the at least one additional observation in a computer database environment.

17. The computer program product of claim 16, further comprising:
computer readable program code configured to receive a request specifying the triggering observation at the computer database environment; and
computer readable program code configured to provide the at least one additional observation possibly associated with the specified triggering observation responsive to the request.

18. The computer program product of claim 17, further comprising:
computer readable program code configured to determine a likelihood that the triggering observation and the at least one additional observation indicate a possible problem exceeds a predetermined threshold; and
computer readable program code configured to generate an alert indicating that the predetermined threshold has been exceeded if it is determined that the predetermined threshold has been exceeded.

19. The computer program product of claim 16, wherein the at least one additional observation comprises observations of events in the data of interest, the events occurring at different times within a specified time period and/or a specified location.

20. The computer program product of claim 16, further comprising computer readable program code configured to identify the triggering observation based on at least one identified pattern defining healthcare events.

21. The computer program product of claim 20, further comprising computer readable program code configured to fine tune the identified patterns and/or add identified patterns to the computer database environment based on the triggering observation and/or the at least one additional observation.

22. The computer readable program product of claim 21, further comprising computer readable program code configured to automatically fine tune the identified patterns and/or add the identified patterns based on normal patterns, the normal patterns including season of the year, month of the year, day of the week, time of day, holidays, cultural and sporting events, geographic location, climatic norms and/or environmental norms and abnormalities.
